(19) United States
(12) Patent Application Publication
(10) Pub. No.: US 2026/0364633 A1
(43) Pub. Date: Nov. 19, 2026

(54) PFAS-FREE COATED TRACK-ETCHED MEMBRANES

(71) Applicant: OXYPHEN GMBH (GERMANY) FILTRATION GROUP CORPORATION, Lottstetten (DE)

(72) Inventors: Vassili ALFIMOV, Zürich (CH); Ulrike GÜNTER, Will (CH); Stefan SPROLL, Ermenswil (CH); Andreas SCHNEEKLOTH, Hamburg (DE)

(73) Assignee: OXYPHEN GMBH (GERMANY) FILTRATION GROUP CORPORATION, Lottstetten (DE)

(21) Appl. No.: 19/478,069

(22) PCT Filed: Apr. 25, 2024
(86) PCT No.: PCT/EP2024/061364

§ 371 Date: Oct. 23, 2025

(30) Foreign Application Priority Data
Apr. 25, 2023 (EP) 23169853.1
Apr. 22, 2024 (EP) 24171620.8

(51) Int. Cl. B05D 7/04; B05D 3/06; B05D 7/26

(52) U.S. Cl. CPC B05D 7/04; B05D 3/068; B05D 7/26

(57) ABSTRACT

The present invention relates to membranes comprising a track-etched membrane substrate comprising pores and a coating at least on one surface of the track-etched membrane substrate, wherein the coating does not comprise per- and polyfluoroalkyl compounds. The inventive membranes provide hydrophobic and even oleophobic capabilities.

The present invention relates to membranes comprising a track-etched membrane substrate comprising pores and a coating at least on one surface of the track-etched membrane substrate, wherein the coating does not comprise per- and polyfluoroalkyl compounds. The inventive membranes provide hydrophobic and even oleophobic capabilities.

### BACKGROUND OF THE INVENTION

Production of “classical” track-etched membranes (TEM) comprises high energetic heavy ion irradiation of polymer foils with subsequent activation of latent tracks, for example, by UV light, as well as an etching treatment performed afterwards. The production of TEM which are currently commercially available in significant volumes is focused on delivering go-through pores that penetrate through the complete thickness of a membrane and which pores have the highest possible homogeneity of pore sizes and pore densities throughout hundreds of square meters of membrane.

Track-etched membranes (TEM) are commonly used in various industries, including mobility applications, biotechnology, pharmaceuticals, and water treatment. They are made of thin polymer films and contain microscopic pores.

At the present date all hydrophobic track-etched membranes on the market are coated with PFAS-coatings (e.g., EP 2 583 733 B1; EP 2 683 176 B1).

When coated with a C6 or C8 PFAS-coating (per- and polyfluoroalkyl substances=PFAS), track-etched membranes can achieve reasonable air flow rates in combination with high hydrophobicity and high oleophobic grades that allow for many venting and filtration applications, including critical safety applications like venting of electronic control units or headlamps in cars.

The PFAS family of chemicals is nowadays under deep scrutiny from various regulatory agencies, including European Chemical Agency (ECHA) in EU and Environmental Protection Agency (EPA) in USA, mainly due to known and suspected cancerogenic characteristics of some of PFASs or their precursors or due to chemical releases during PFAS production or decomposition. C8 PFAS are nowadays even prohibited for environmental reasons.

Thus, there is a need for new environmentally friendly track-etched membranes.

### SUMMARY OF THE INVENTION

According to the present invention, this problem is solved by the provision of membranes comprising a track-etched membrane substrate comprising pores and a coating at least on one surface of the track-etched membrane substrate, wherein the coating does not comprise per- and polyfluoroalkyl compounds.

The inventive, preferably 100%, PFAS-free hydrophobic and reasonably oleophobic track-etched membrane with PFAS-free coating is made of a polymer film, typically PET, PC, PEN, PI or PEEK that contains homogeneously distributed microscopic almost cylindrical pores of equal size, as in the traditional track-etched membranes, i.e., the track-etched membrane substrate. However, it has one of several unique PFAS-free coatings that gives it hydrophobic and reasonably oleophobic capabilities. The PFAS-free coating is a thin layer of a polymer material that is deposited onto the surface of the membrane using a specialized technique as herein described.

Another aspect of the invention relates to a method for depositing a PFAS-free hydrophobic coating on a track-etched membrane substrate.

### DETAILED DESCRIPTION

The invention presented here describes a novel kind of membranes comprising a track-etched membrane substrate comprising pores and a coating at least on one surface of the track-etched membrane substrate, wherein the coating does not comprise per- and polyfluoroalkyl compounds.

Track-etching is a technique well-known to the person skilled in the art. Exemplary methods for producing track-etched membranes are described in the publications listed herein or, in patent documents like U.S. Pat. No. 3,612,871 B2, DD-AP 235923 and DE 195 36 033 A1. The essence of the technology lies in irradiation of thin polymer films by charged particles of high energy (ions, protons, α-particles, etc.) or with fragments of heavy nuclei fissions (argon, krypton, xenon, uranium, etc.) resulting in radiation degradation of macromolecules and formation of damaged channels (i.e., so-called “tracks”) in the material. During further etching of the irradiated films with solutions of alkalis, acids, oxidants, and other chemical reagents, the material fragments are washed out from the tracks, and a regular through porosity is formed (P. Apel, Radiation Measurements 34(1), 559-566, 2001).

The material of the track-etched membrane substrate, i.e. a polymer film, preferably contains preferably at least one of a hydrolyzable polymer and an oxidatively-destructible polymer. Preferably it is selected from polyethylene terephthalate (PET), polycarbonate (PC), polyimide (PI), polyethylene naphthalate (PEN), polyether ether ketone (PEEK), and other polymers or composite materials having similar properties. Polyethylene terephthalate (PET), polycarbonate (PC), polyimide (PI), polyethylene naphthalate (PEN), polyether ether ketone (PEEK), are in particular preferred. Polyethylene terephthalate (PET) is most preferred.

The thickness of the track-etched membrane substrate is not particularly limited. The thickness can be adapted and chosen according to the intended use. For example, thicker membranes may provide an improved water entry pressure (WEP) and in particular improve the long term WEP performance of a membrane. This effect is supported by experimental data provided herein. Water entry pressure is the minimum pressure required to force water through the largest opening of a dry hydrophobic membrane. Thinner membranes may be used as long as being sufficiently supported. Preferably, the thickness is in the range of 3-200 μm, most preferably 20-75 μm.

The inventive membranes and in particular the coating do not comprise per- and polyfluoroalkyl compounds (PFAS), i.e. are essentially free of PFAS.

Per- and polyfluoroalkyl compounds are synthetic organofluorine chemical compounds that have multiple fluorine atoms attached to an alkyl chain. An early definition, from 2011, required that they contain at least one perfluoroalkyl moiety, —CₙF₂ₙ₊₁— (Buck et al. “Perfluoroalkyl and polyfluoroalkyl substances in the environment: terminology, classification, and origins”. Integrated Environmental Assessment and Management. 7 (4): 513-41, 2011).

Beginning in 2021, the Organisation for Economic Co-operation and Development (OECD) expanded their terminology, stating that “PFASs are defined as fluorinated substances that contain at least one fully fluorinated methyl or methylene carbon atom (without any H/CI/Br/l atom attached to it), i.e. with a few noted exceptions, any chemical with at least a perfluorinated methyl group (—CF₃) or a perfluorinated methylene group (—CF₂—) is a PFAS.”

Herein, the definition of OECD shall be followed. Within the meaning of the present invention, i.e. any chemical with at least a perfluorinated methyl group (—CF₃) or a perfluorinated methylene group (—CF₂—) is a PFAS.

In particular, the inventive membranes and in particular the coating do not comprise PFAS compounds having 8 carbon atoms (C8, such as PFOA, perfluorooctanoic acid and PFOA-related compounds according to REACH) and/or 6 carbon atoms (C6, such as PFHxS, perfluorohexanesulfonic acid or PFHxA, perfluorohexanoic acid, and related compounds according to REACH). Of course, it is preferred that the inventive membrane is free of C6 and C8 PFAS or any other PFAS.

Also not comprised by the inventive membrane shall be perfluorinated carboxylic acids with nine to fourteen carbon atoms such as perfluorononanoic acid (PFNA), perfluorodecanoic acid (PFDA), perfluoroundecanoic acid (PFUnDA), perfluorododecanoic acid (PFDoDA), perfluorotridecanoic acid (PFTrDA) or perfluorotetradecanoic acid (PFTeDA).

According to a preferred embodiment, the inventive membranes and in particular the coating are 100% free of any PFAS.

The pores of the track-etched membrane substrate extend through the track-etched membrane substrate in a thickness direction such that the track-etched membrane substrate has openings corresponding to the plurality of through pores. Preferably, the pores have a constant cross-sectional shape and extending through the track-etched membrane substrate along a straight line. The direction of the pores within the membrane may be adjusted during irradiation process within an angle ranging from 0°-60°, preferably 30°-50° (measured from a vertical line that is perpendicular to the surface of the membrane).

The pores each have preferably a size of 0.1 to 20 μm, more preferably 0.1 to 10 μm, in particular 0.15 to 1.0 μm. According to the invention, the “size” of a pore means the diameter of a circle having an area equal to the cross-sectional area of the through pore. As known to the person skilled in the art, the sizes of the pores can be adjusted by etching time or the concentration of an etching treatment liquid.

Preferably, the pore size is preferably also highly uniform and homogeneous over the membrane substrate area and in especially preferred embodiments of the invention, the standard deviation of pore size varies between 0% and 10%, preferably between 0% and 5%, most preferred between 0% and 3%.

The shape of the pores is not limited, but the pores are preferably of conical, semi-cylindrical, almost cylindrical and/or cylindrical shape. Preferably, the pores are of uniform shape, in particular uniform shape and size.

According to a preferred embodiment, the track-etched membrane substrate comprises homogeneously distributed microscopic almost cylindrical pores of equal size.

The pores are preferably uniformly distributed such that a density of the plurality of through pores falls within specific limits included in a range from 1,000 to 1×10¹⁰ pores per cm², preferably 1×10⁶ to 8×10⁸ pores per cm². The densities of the pores is set at the irradiation step, e.g., depending on the amount of ions applied at the time of ion beam irradiation. The pore sizes and hence the porosity can be adjusted during the etching.

Preferably, the pore density is preferably also highly uniform and homogeneous over the membrane substrate area and in especially preferred embodiments of the invention, the standard deviation of pore density varies between 0% and 10%, preferably between 0% and 5% and at most preferred between 0% and 3%.

The PFAS free coating is provided on at least one surface of the track-etched membrane substrate. Although it is preferred to be provided on both surfaces and inside the pores, the coating may also be provided on one surface and possibly at partial length of the pores of the track-etched membrane substrate.

The coating may coat the outer surface of the track-etched membrane substrate and the walls of the pores in the substrate or the outer surface only. According to a preferred embodiment, the coating covers both surfaces and the pores of the membrane substrate.

According to preferred embodiments the coating is thinner than the pore radius.

According to preferred embodiments the coating is based on an acrylic copolymer or alkyl urethane, i.e. an acrylcopolymer or alkyl polyurethane.

Acrylic copolymers are in particular preferred. The term “acrylic copolymer” is well understood by the person skilled in the art. In general, an acrylic polymer or acrylate polymer (also known as acrylic or polyacrylate) is any of a group of polymers prepared from acrylate monomers, wherein an acrylic copolymer is a polymer derived from more than one species of monomer, i.e. one more species of monomer beside acrylate monomer, such a methacrylic acid.

Examples of preferred acrylic polymers are polymethyl methacrylate, poly(2-ethylhexyl acrylate), poly(tert-butyl acrylate), poly(styrene-co-methyl methacrylate), poly(butyl acrylate-co-methyl methacrylate), poly(acrylnitril-co-butylacrylate), poly(2-ethylhexyl acrylate-co-butyl acrylate and similar polymers with the general structure, i.e. poly acrylates:

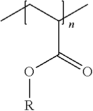

As understood by the person skilled in the art “polyurethane” refers to a class of polymers composed of organic units joined by carbamate (urethane) links. In contrast to other common polymers such as polyethylene and polystyrene, polyurethane may be produced from a wide range of starting materials.

Examples of preferred polyurethanes are alkylurethanes (picture below)

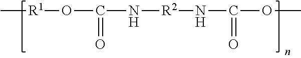

with R1, R2 as CₙHₙ₊₂

According to a preferred embodiment the coating is provided by applying:
A) a dispersion of paraffin wax (a mixture of various saturated CnH2n+2 (n being an integer, preferably. 18-70), for example, vaseline, ceresin), acrylic copolymer and araliphatic ether alcohol or
B) a dispersion of alkyl urethane and araliphatic ether alcohol, and subsequent curing.

A dispersion of paraffin wax and acrylic copolymer is in particular preferred.

The dispersion may comprise an additional crosslinker, in particular a dispersion of a dimethylpyrazole blocked polyisocyanate.

According to further preferred embodiments ethoxylated fatty alcohol is added to the dispersion.

Herein particular preferred PFAS-free coatings are provided by:
1) a dispersion of paraffin wax and acrylic co-polymer with or without an additional crosslinker like a dispersion of a dimethylpyrazole blocked polyisocyanate with or without addition of ethoxylated fatty alcohol and an araliphatic ether alcohol
   Example: Phobotex R-Ace, together with Phobol Extender UXN and Invadine PBN, from Huntsman Textile Effects/Archroma, or
2) a dispersion of alkyl urethane with or without an additional crosslinker like a dispersion of a dimethylpyrazole blocked polyisocyanate with or without addition of ethoxylated fatty alcohol and an araliphatic ether alcohol
   Example: Zelans R3 (Chemours) together with Phobol Extender UXN and Invadine PBN (both from Huntsman Textile Effects/Archroma), or
3) different dispersions either as stand-alone coating solution or in any mixture:
   a) modificated fats, preferably on the basis of a palm oil derivative with or without additional crosslinker, wherein the crosslinker is preferably based on polyisocyante, in particular on the basis of a dimethylpyrazole blocked polyisocyanate,
   b) acrylic copolymer, in particular based on ethoxylated alcohol and alkyl acrylate,
   c) paraffin zirconium salt composition
   Examples: Texaphob HFF-C; HFF; HFF-PZ; or
4) solutions of polyolefines in suitable solvents, with or without additional crosslinker, for example, ethoxylated fatty alcohol with acrylic copolymer in isopropanol.

“Araliphatic” as used herein relates to an essentially aliphatic compound containing one or more aryl groups.

The combinations of PFAS-free coatings and track-etched membrane (for example, PET, PC, PEN, PI or PEEK base material) described are designed to provide excellent hydrophobic and reasonable oleophobic PFAS-free membranes as a new unique membrane family that is an environmentally friendly alternative for the common PFAS-coated track-etched membranes as well as to expanded polytetrafluoroethylene (ePTFE) in non-essential applications.

The unique combination of the track-etched membrane substrate and the proposed PFAS-free coating results in reduced environmental impact: No PFAS in production, use or decomposition of membrane, together with comparable hydrophobic performance and reasonable oleophobic performance.

A further aspect of the present invention relates to a method for depositing an essentially PFAS free coating on a track-etched membrane substrate comprising the steps:
(a) providing a track-etched membrane substrate,
(b) applying
   a dispersion of paraffin wax, acrylic copolymer and araliphatic ether alcohol or
   a dispersion of alkyl urethane and araliphatic ether alcohol or
   a solution of polyolefins in suitable solvents, and
(c) curing and/or drying.

The provided coating as well as the track-etched membrane substrate are as herein described above.

In step (b), application of a dispersion or solution can be by dip coating, spray coating or plasma coating procedures, preferably by dip coating procedure.

According to preferred embodiments, the dispersions or solutions according to step (b) may comprise an additional crosslinker, in particular a dispersion of a dimethylpyrazole blocked polyisocyanate. It may be also preferred to add ethoxylated fatty alcohol. According to an especially preferred embodiment, a dispersion of a dimethylpyrazole blocked polyisocyanate and ethoxylated fatty alcohol is added.

In an optional step (d), the membrane provided according to step (c) can be laminated to a further carrier film or a PFAS-free nonwoven substrate, for example made of kernmantle fibers. An example could be a PET+CoPET kernmantle nonwoven.

Thus, according to a further aspect, the invention relates to a structure, such as a membrane, comprising the track-etched membrane substrate and coating as herein described and a further carrier, such as a polymer film or a nonwoven substrate.

The proposed unique combinations of the track-etched membrane substrate and the PFAS-free coatings offer a range of 100% PFAS-free excellent hydrophobic and reasonably oleophobic track-etched membranes that were previously unavailable in the market.

The proposed PFAS-free track-etched membranes are aimed at the reduction of PFAS-releases to the environment due to production, use and end-of-life of traditional PFAS-coated track-etched membranes as well as ePTFE. This patent application discloses these unique combinations, which has significant potential in various industries, including consumer electronics, mobility, automotive lightning, electronic control units, battery technology, biotechnology, pharmaceuticals, and water treatment.

A further aspect of the invention relates to the use of the inventive membranes and structures in implantable medical devices, photographic coatings and for photolithographic processes, oil and water repellent textiles and industrial polymers for specific membranes or sealants.

It will be apparent to the skilled person that many of the above explanations regarding preferred embodiments apply to specific circumstances and especially the general use of the membrane. For other possible uses but also for specific application, adaptions and variations of such preferred embodiments might be required and advantageous. Such adaptions and variations can be easily made by the skilled person based on his knowledge and the overall information provided herewith.

The invention will be further illustrated by the following Figures and Examples, which are not intended as limiting the scope of the invention defined by the appended claims.

### FIGURES

FIG. 1 is a graph illustrating the effect of membrane thickness [μm] on long-term L-WEP [mbar]

FIG. 2 is a graph illustrating the effect of membrane thickness [μm] on short-term S-WEP [mbar]

FIG. 3 is a graph illustrating the effect of membrane thickness [μm] on the ratio of L-WEP/S-WEP

FIG. 4 is a graph illustrating the air flow rate depending on (A) membrane thickness and (B) pore size

FIG. 5 is a graph illustrating the effect of pore size [μm] on S-WEP [mbar]

### EXAMPLES

### 1. Effect of PFAS-Free Coating on WEP

Oxyphen 20.IC00.507.502 track-etched membrane (35 μm PET, with 50×10⁶ pores/cm² and about 0.5 μm pore diameter (Bubble Point)) has in combination with its usual PFAS-coating about 2 bar short-term water entry pressure (S-WEP) and oleophobic grade 6.5 on AATCC 118 Test. The AATCC 118 Test is known to the person skilled in the art.

The same membrane with a new PFAS-free coating 1, 2 or 3 as proposed above has about 20% less S-WEP and oleophobic grade 1.5 on AATCC 118 Test, with liquids for Grade 3-5 are showing long-term stable “C-Type”-droplets, which is also an impressive repellence performance.

### 2. Effect of Membrane Thickness on WEP

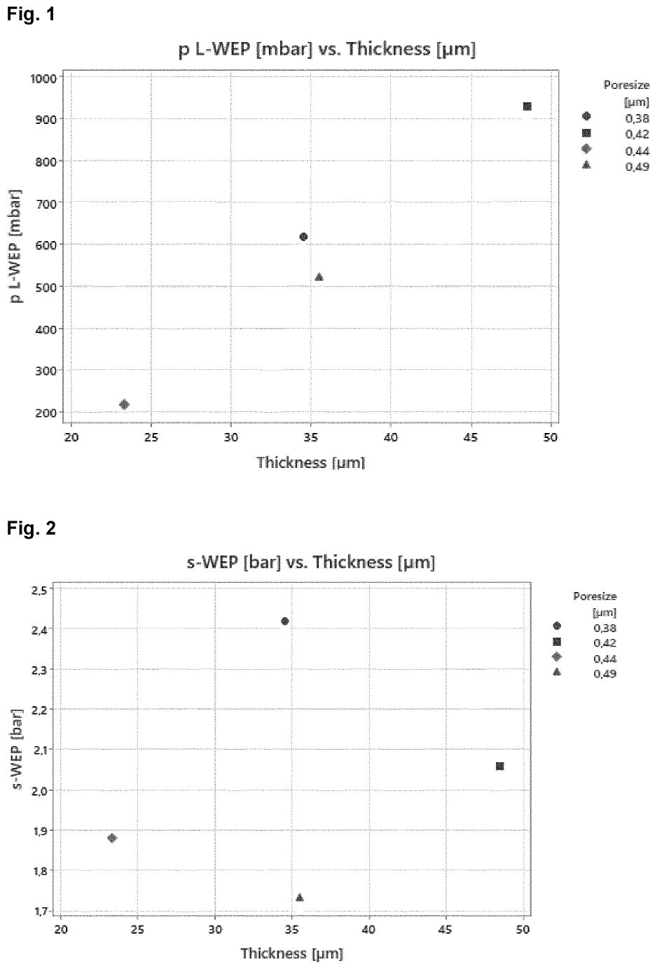

To demonstrate the effect of membrane thickness on water entry pressure, a specific long-term water entry pressure (p L-WEP) was recorded, so that 50% of the samples was still OK at 10 min time. The membranes with about the same minimal pore sizes in a range of about 0.4 μm (according to the bubble point testing method) were selected with 23 μm, 36 μm and 50 μm thicknesses and 50-100 Mio pores/cm². The results clearly show the dependence “thicker membranes give more long-term water ingress protection” (FIG. 1). The effect is strong, with almost 5× increase in p L-WEP with 2× increase in thickness.

p L-WEP is one way to characterize a membrane water repellency, measured as “put pressure, hold it and observe”. Another, a quicker way to characterize a water repellency that is often used in praxis is to steadily increase a water pressure until the leakage happens (p S-WEP or s-WEP or “rise the pressure until the membrane leaks”). This measurement is valuable for an estimate of a short-time quick load on membrane. The membranes that were selected for the example does not show a dependence s-WEP vs thickness, as in case of for p-LWEP vs thickness and are all about 2 bar in s-WEP (FIG. 2).

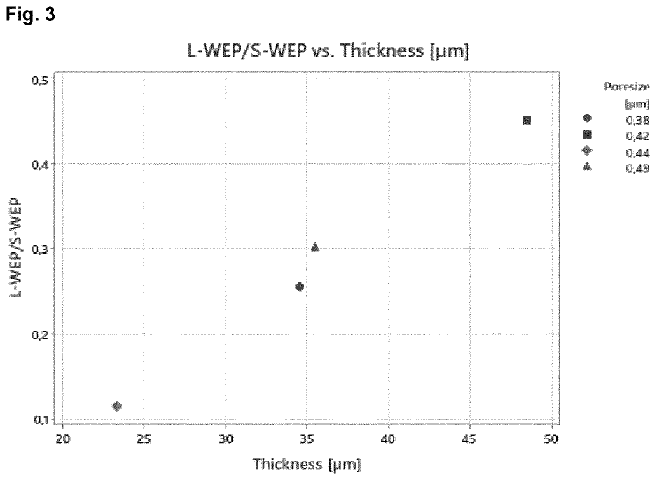

The ratio of p L-WEP/p S-WEP is still significantly influenced by the thickness, showing that the effect of thickness of L-WEP is stronger (FIG. 3).

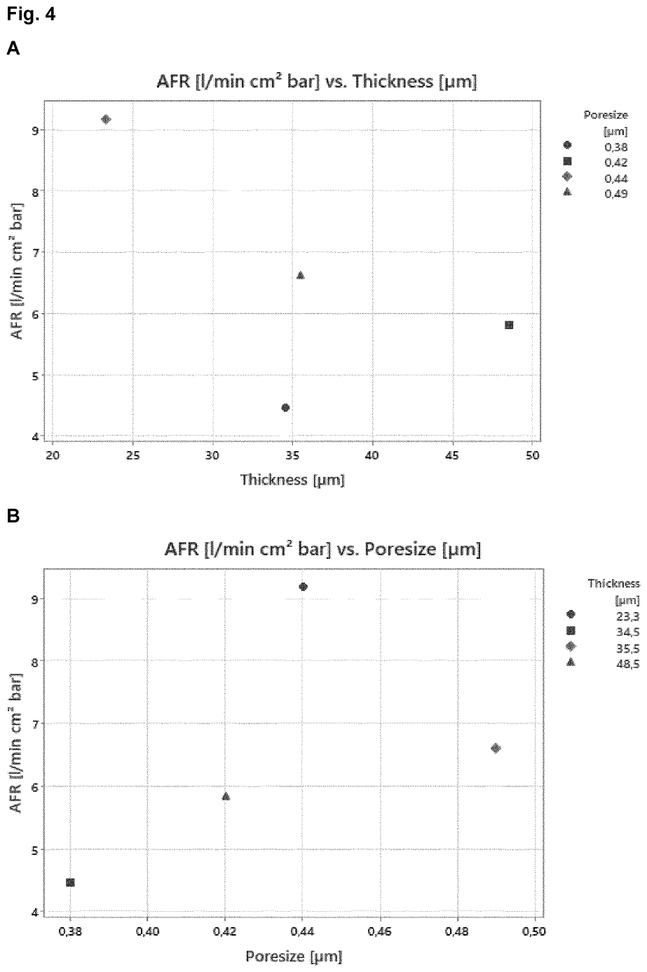

Air flow rate is 4.5-9 L/min/cm²/bar for the selected samples, without a clear trend with thickness or pore size (FIG. 4).

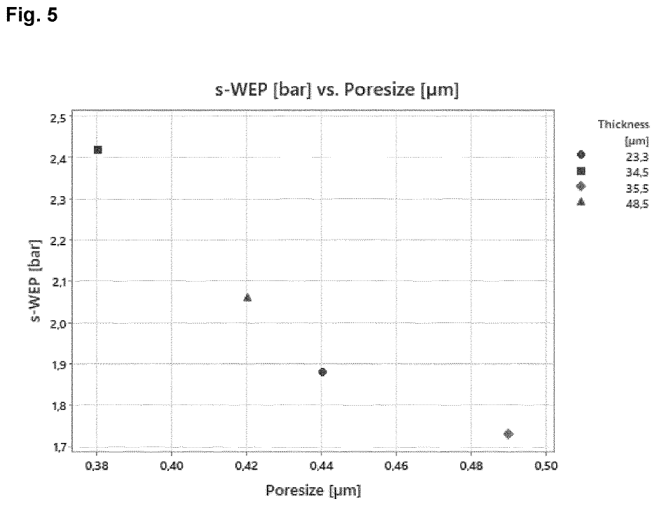

There is a minor reduction of s-WEP with pore sizes, but this effect is not as strong as the effect of thickness on p L-WEP (FIG. 5).

Consequently, the observed effect of thickness on p L-WEP is the major effect in the presented sample dataset and shows that the move towards more thicker membranes allows to provide more long-term water entry protection.

1. A membrane comprising a track-etched membrane substrate comprising pores and a coating at least on one surface of the track-etched membrane substrate, wherein the coating does not comprise per- and polyfluoroalkyl compounds.

2. The membrane according to claim 1, wherein the material of the track-etched membrane substrate is selected from polyethylene terephthalate (PET), polycarbonate (PC), polyimide (PI), polyethylene naphthalate (PEN), polyether ether ketone (PEEK), and other polymers having similar properties, preferably PET or PC.

3. The membrane according to claim 1, wherein the track-etched membrane substrate comprises homogeneously distributed almost cylindrical pores of equal size.

4. The membrane according to claim 1, wherein the outer surface of the track-etched membrane substrate and the walls of the pores in the substrate are coated.

5. The membrane according to claim 1, wherein the coating is thinner than the pore radius.

6. The membrane according to claim 1, wherein the pore size is 0.1 to 20 μm, preferably 0.1 to 10 μm, in particular 0.15 to 1.0 μm.

7. The membrane according to claim 1, wherein the track-etched membrane substrate has 1,000 to 1×10¹⁰ pores per cm², preferably 1×10⁶ to 8×10⁸ pores per cm².

8. The membrane according to claim 1, wherein the coating is 100% free of per- and polyfluoroalkyl compounds.

9. The membrane according to claim 1, wherein the coating is provided by applying a dispersion of paraffin wax, acrylic copolymer and aralphatic ether alcohol or a dispersion of alkyl urethane and aralphatic ether alcohol, preferably a dispersion of paraffin wax and acrylic copolymer, and subsequent curing.

10. The membrane according to claim 9, wherein the dispersion comprises an additional crosslinker, in particular a dispersion of a dimethylpyrazole blocked polyisocyanate.

11. The membrane according to claim 9, wherein ethoxylated fatty alcohol is added.

12. The membrane according to claim 1, wherein the coating is provided by applying a solution of polyolefins in suitable solvents with or without additional crosslinker.

13. A method for depositing an essentially PFAS free coating on a track-etched membrane substrate, the method comprising the steps:
(a) providing a track-etched membrane substrate,
(b) applying
a. a dispersion of paraffin wax, acrylic copolymer and aralphatic ether alcohol; or
b. a dispersion of alkyl urethane and araliphatic ether alcohol; or
c. a dispersion based on
i) modified fats, preferably on the basis of a palm oil derivative, with or without additional crosslinker,
ii) acrylic copolymer, in particular based on ethoxylated alcohol and alkyl acrylate,
iii) paraffin zirconium salt composition or
iv) any mixture thereof; or
d. a solution of polyolefines in suitable solvents with or without additional crosslinker;
and
(c) curing and/or drying.

14. A structure comprising a membrane according to claim 1 and a further carrier, such as a polymer film or a nonwoven substrate.

15. A method of using a membrane according to claim 1 in implantable medical devices, photographic coatings and for photolithographic processes, consumer and industrial electronic protection, oil and water repellent textiles and industrial polymers for specific membranes or sealants.
